(19) United States
(12) Patent Application Publication
(10) Pub. No.: US 2012/0252357 A1
(43) Pub. Date: Oct. 4, 2012

(54) System and Method for Monitoring and Managing the Communications of Remote Devices

(76) Inventors: Bryan Tarleton, Buford, GA (US); Michael Criscolo, Alpharetta, GA (US); Jeffrey O. Smith, Dallas, TX (US)

(21) Appl. No.: 13/439,199

(22) Filed: Apr. 4, 2012

Related U.S. Application Data
(60) Provisional application No. 61/471,484, filed on Apr. 4, 2011.

(51) Int. Cl. H04W 24/00; H04W 8/04

(52) U.S. Cl. 455/26.1; 455/500; 455/517

(57) ABSTRACT

A system and method of monitoring the communications of remote devices is described. The system includes a plurality of remote devices, where each remote device has one or more sensors and a communications transceiver. A control center, which includes a historical usage database reflecting historical usage patterns for each of the plurality of remote units, analyzes the communications for each of the plurality of remote devices against the historical usage patterns for that remote device to determine when that remote device is malfunctioning or approaching a usage threshold. The control center is then operable to take appropriate corrective action in response to the analysis.

### CROSS REFERENCE TO RELATED INFORMATION

This application claims the benefit of U.S. Provisional Patent Application Ser. No. 61/471,484, filed Apr. 4, 2011.

### TECHNICAL FIELD

The present disclosure is directed to machine-to-machine communications and monitoring, and more particularly to monitoring the usage of communications networks by each of a large number of distributed mobile units.

### BACKGROUND OF THE INVENTION

Many companies use large numbers of mobile assets such as vehicles, shipping containers, barges, commercial equipment, palettes, and other similar objects in their everyday business. Other companies and industries use remote sensors to collect data that is used in their businesses. More and more companies are turning to remote asset tags, sensors and tracking devices to obtain access to remotely collected data, continuous location and status updates on those mobile objects and sensors. These remote devices use a wide range of existing satellite, cellular and other tracking services to keep tabs on the mobile or remote objects. In many instances, those remote devices also use cellular, wireless networking, or even satellite communications to report their location, data and/or status to a monitoring center.

The cellular (or satellite) operators may charge by the minute or by the kilobyte for their services, or may have a flat fee per month, or other billing period, for usage below a threshold with per minute or per kilobyte charges over the threshold. These additional charges can mount quickly and can incur large excess charges for the owner of the mobile objects. These overages can result from the normal operation of the devices or can result from a malfunctioning device that uses far more cellular bandwidth than intended.

What is needed is a system that can monitor communication and communication patterns of mobile objects/units and to act when those units approach a usage threshold.

### BRIEF SUMMARY OF THE INVENTION

An embodiment of a method for monitoring the communications of remote devices is described where the method receives data on communications usage from each of a plurality of remote devices and analyzes the communications for each of the plurality of remote devices to determine when that remote device is approaching a usage threshold. The method then can take appropriate corrective action in response to the analysis.

In another embodiment, a method for monitoring the communications of remote devices is described that receives data on communications usage from each of a plurality of remote devices, and analyzes the communications for each of the plurality of remote devices against a historical pattern of usage for that remote device to determine when that remote device is malfunctioning. The method then can take appropriate corrective action in response to the analysis.

In yet another embodiment, a system and method of monitoring the communications of remote devices is described. The system includes a plurality of remote devices, where each remote device has one or more sensors and a communications transceiver. A control center, which includes a historical usage database reflecting historical usage patterns for each of the plurality of remote units, analyzes the communications for each of the plurality of remote devices against the historical usage patterns for that remote device to determine when that remote device is malfunctioning or approaching a usage threshold. The control center is then operable to take appropriate corrective action in response to the analysis.

The foregoing has outlined rather broadly the features and technical advantages of the present invention in order that, the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram of an embodiment of a system for monitoring the communications and communication patterns of multiple mobile units;

FIG. 2 is a block diagram of an embodiment of an asset tag for a mobile unit having location and status determining capabilities; and

FIG. 3 is a flow chart for an embodiment of a method for monitoring and managing the communications of remote devices.

### DETAILED DESCRIPTION OF THE INVENTION

Excess usage of the communications networks by the mobile units can result in large overage charges by the network providers. Excess usage can come from deviations from normal operating conditions, such as a device that is in the field longer than normal, or more devices in the field that is usual, or can come as a result of a malfunctioning device that transmits data more often than intended. In either event, the operator or owner of the devices would only become aware of the problem after they have received a bill for the excess airtime. Embodiments of the present invention monitor the communications of each mobile device and analyze that information in view of historical usage and patterns to detect malfunctioning devices or devices that are approaching a usage threshold.

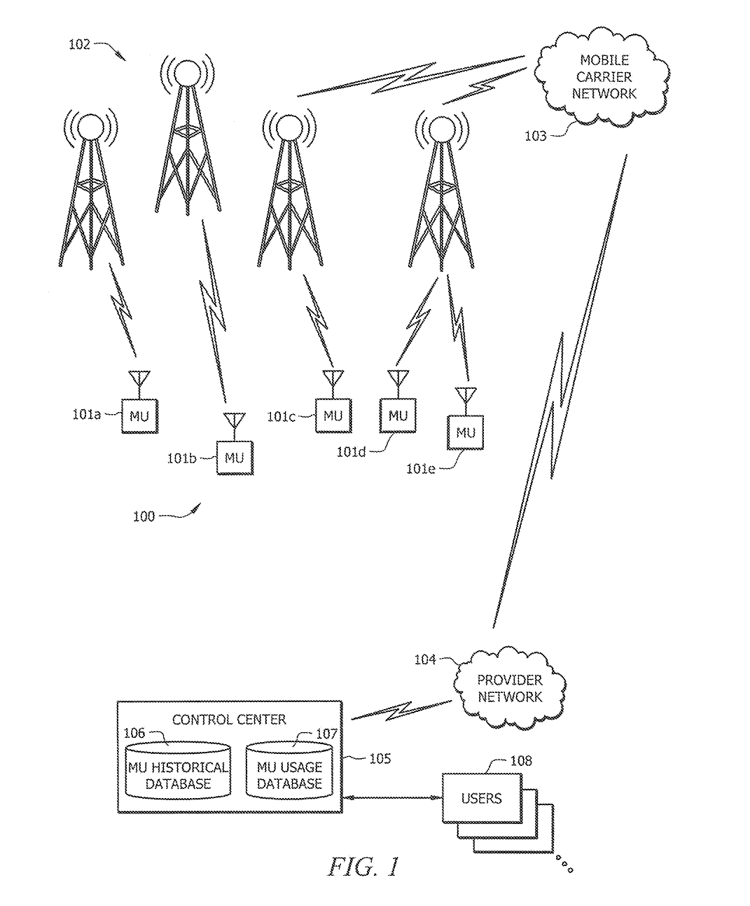

Referring now to FIG. 1, the present invention describes an embodiment of a system 100 for monitoring the communications of a large number of remote or mobile units 101a through 101e that are programmed to report location, data and/or status periodically, in response to an event, or in response to a request by a monitoring center. The mobile units use cellular or satellite (not shown) networks to send data to a control or monitoring center 105 which collects the location and/or status data for each of the mobile units 101a through 101e. While a cellular network having cell stations 102 and carrier network 103 are shown communicating with a provider network 104 connected to control center 105, any type or combination of communications network can be used without departing from the scope of the concepts described herein. Other examples of communications networks may include satellite, wireless networking, radio frequency or any other network with the requisite functionality.

The control or monitoring center 105 monitors each device 101a through 101e. In addition to a historical usage database for the mobile units 106, the control center 105 can keep a current usage database 107 for each device and groups of devices. By monitoring the communications, the monitoring center can detect deviations from historical communication patterns that result from malfunctioning devices and can also detect devices that are approaching usage threshold and can either disable those devices or send alerts to the operator/owner/manager 108 of the device to allow the owner to take corrective action if desired.

The system preferably uses the data channels of cellular networks 103 to communicate with the remote devices, but can use any wireless communications technology available to the mobile unit, including satellite and wireless networking technologies. In addition the protocols used in preferred embodiments of the system are agnostic to technical details of the specific devices and can be used across a spectrum of devices and technologies. While a particular number of mobile units are represented in FIG. 1, any number of mobile units can be accommodated using the concepts described herein.

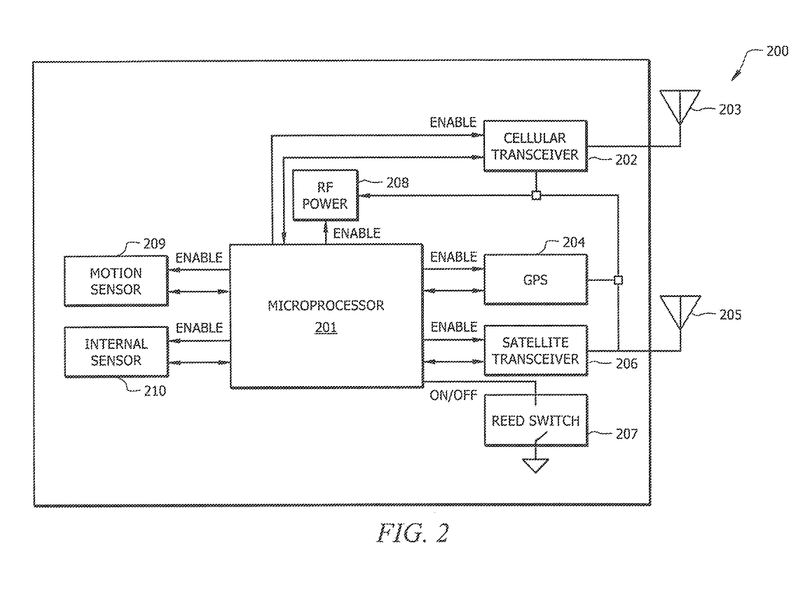

Referring now to FIG. 2, an embodiment of a remote sensor or mobile asset tag that can be used with each remote or mobile unit is described. The unit, or tag, 200 includes a microprocessor 201 programmable to execute desired instructions and to control the operation of tag 200. The processor 201 may have internal memory capable of storing data and programming information or may use memory external to the microprocessor. The tag 200 also includes a cellular transceiver 202 and associated cellular antenna 203 to perform cellular communications. Power for the cellular transceiver is supplied by RF power module 208. The tag 200 also includes a satellite location determination device 204, which can be GPS or satellite service based, and a satellite transmitter, receiver or transceiver 206, which uses satellite antenna 205.

As described, communications with the control center can be done using satellite, cellular or other long range communication systems. Sensors 209, 210 can be embedded in or connected to the device to collect data, detect motion, detect the presence of another object, or any other type of data or environmental information. Such information can be collected and reported to the data center or can also be used to trigger actions by the mobile device. Reed switch 207 is an electrical switch that is activated by a magnetic field and can be used to enable or disable the device. While unit 200 is shown with a particular combination of sensors and communication elements, the specific configuration of each device can vary according to its intended use and may include a particular sensor or array of sensor, may include one communications system or multiple communications systems, and may include any of a variety of location determination modules or none at all.

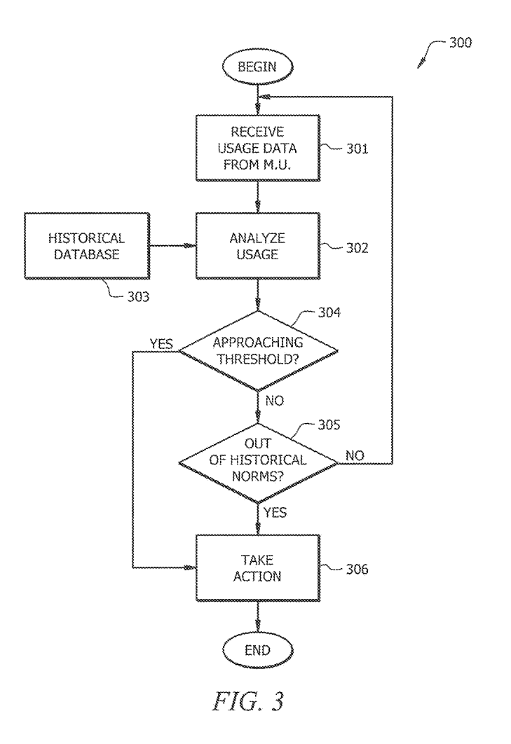

Referring now to FIG. 3, a flow chart of an embodiment of a method 300 for monitoring and managing the communications of remote devices/mobile units is described. The method, as shown in block 301, receives or tracks usage data for each mobile unit by either directly monitoring the communications, receiving usage updates from the mobile unit or receiving usage data from the network carrier. That data is then analyzed, as shown in block 302, in conjunction with historical usage data 303 for the device. The method then proceeds to determine, based on the analysis, whether that particular mobile unit is approaching a usage threshold, as shown in block 304. If a usage threshold is approaching, the monitoring center can take appropriate action, as shown by block 306. The method also determines, shown by block 305, if the mobile unit is operating outside of historical norms and could be malfunctioning. If there is deviation from the historical usage pattern, the monitoring center can again take appropriate action, as shown by block 306.

Appropriate action in preferred embodiments includes sending notices to the owner/operator/manager of the mobile unit, or disabling the communications of the mobile unit in question. Disabling the mobile unit can involve sending new instructions to the unit, or more preferably removing the mobile unit from the associated home location register (HLR). The disabling action could be temporary, i.e. until the start of the next billing cycle, or could be more permanent in the case of a malfunctioning device, disabling it until the device can be serviced to correct the error.

The data collection and analysis can be performed on any time frame, but is preferably done regularly over short intervals to ensure that a malfunctioning device is caught quickly. For example, the usage data can be analyzed hourly looking for deviations from historical patterns.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for monitoring the communications of remote devices comprising:
receiving data on communications usage from each of a plurality of remote devices;
analyzing the communications for each of the plurality of remote devices to determine when that remote device is approaching a usage threshold; and
taking appropriate corrective action in response to the analysis.

2. The method of claim 1 wherein appropriate corrective action comprises sending a notice to an operator of the remote device.

3. The method of claim 1 wherein appropriate corrective action comprises disabling the communications of that remote device.

4. The method of claim 3 wherein disabling that remote device comprises sending new instructions to the unit.

5. The method of claim 3 wherein disabling that remote device comprises removing that remote device from an associated home location register (HLR).

6. The method of claim 1 wherein each remote device comprises one or more sensors, a communications transceiver, and location detection functionality.

7. The method of claim 1 wherein the communications transceiver is a cellular transceiver.

8. The method of claim 1 further comprising analyzing the communications for each of the plurality of remote devices against a historical pattern of usage for that remote device to determine when that remote device is malfunctioning.

9. A method for monitoring the communications of remote devices comprising:
receiving data on communications usage from each of a plurality of remote devices;
analyzing the communications for each of the plurality of remote devices against a historical pattern of usage for that remote device to determine when that remote device is malfunctioning; and
taking appropriate corrective action in response to the analysis.

10. The method of claim 9 wherein appropriate corrective action comprises sending a notice to an operator of the remote device

11. The method of claim 9 wherein appropriate corrective action comprises disabling the communications of that remote device.

12. The method of claim 11 wherein disabling that remote device comprises sending new instructions to the unit.

13. The method of claim 11 wherein disabling that remote device comprises removing that remote device from an associated home location register (HLR).

14. A system monitoring the communications of remote devices, the system comprising:
a plurality of remote devices, each remote device comprising one or more sensors and a communications transceiver; and
a control center, the control center including a historical usage database reflecting historical usage patterns for each of the plurality of remote units, wherein the control center analyzes the communications for each of the plurality of remote devices to determine when that remote device is approaching a usage threshold;
wherein the control center is operable to take appropriate corrective action in response to the analysis.

15. The system of claim 14 wherein appropriate corrective action comprises sending a notice to an operator of the remote device.

16. The system of claim 14 wherein appropriate corrective action comprises disabling the communications of that remote device.

17. The system of claim 16 wherein disabling that remote device comprises sending new instructions to the unit.

18. The system of claim 16 wherein disabling that remote device comprises removing that remote device from an associated home location register (HLR).

19. The system of claim 14 wherein one or more of the plurality of remote units includes location detection functionality.

20. The system of claim 14 wherein the control center also analyzes the usage against the historical usage patterns for that remote device to determine if the device is malfunctioning.
